(19) United States
(12) Patent Application Publication
(10) Pub. No.: US 2011/0280176 A1
(43) Pub. Date: Nov. 17, 2011

(54) A DEVICE AND METHOD FOR TRANSMITTING RELAY SYNCHRONIZATION SIGNAL ON LTE-A SYSTEM BASED ON ORTHOGONAL FREQUENCY DIVISION HAVING A MULTI-HOP RELAY

(75) Inventors: Heesoo Lee, Daejeon (KR); Jae Young Ahn, Daejeon (KR); Taegyun Noh, Daejeon (KR); Kyoung Seok Lee, Daejeon (KR); Hyun-Il Yoo, Seoul (KR); Chang-Hwan Park, Seoul (KR); Kyung Soo Woo, Seoul (KR); Yong Soo Cho, Seoul (KR)

(73) Assignees: ELECTRONICS AND TELECOMMUNICATIONS RESEARCH INSTITUTE, DAEJON (KR); CHUNG-ANG UNIVERSITY INDUSTRY-ACADEMY COOPERATION FOUNDATION, SEOUL (KR)

(21) Appl. No.: 13/144,857

(22) PCT Filed: Jan. 18, 2010
(86) PCT No.: PCT/KR2010/000301

§ 371 Date: Jul. 15, 2011

(30) Foreign Application Priority Data
Jan. 16, 2009 (KR) 10-2009-0003745
Jan. 15, 2010 (KR) 10-2010-0003839

(51) Int. Cl. H04W 88/04

(52) U.S. Cl. 370/315

(57) ABSTRACT

Provided is a relay-synchronization signal (R-SS) transmitting apparatus and method in an orthogonal frequency division multiplexing (OFDM)-based Long Term Evolution Advanced (LTE-A) system having a multi-hop relay. The R-SS transmitting apparatus generates a R-SS having the same peak-to-average power ratio (PAPR) characteristic as a synchronization signal (SS) and having a lower correlation characteristic than the SS, using the SS for synchronization with a terminal, for synchronization between a relay and a base station, for a synchronization between a relay and a subordinate relay, and for monitoring, by a relay, an adjacent base station or an adjacent relay

### TECHNICAL FIELD

The present invention relates to a relay-synchronization signal (R-SS) transmitting apparatus and method in an orthogonal frequency division multiplexing (OFDM)-based Long Term Evolution Advanced (LTE-A) system including a multi-hop relay, and more particularly, to an R-SS transmitting apparatus and method that generates an R-SS having a peak-to-average power ratio (PAPR) characteristic that is not deteriorated compared with a existing synchronization signal (SS), and having the same correlation characteristic as the existing SS.

### BACKGROUND ART

A relay may transmit a synchronization signal (SS) for synchronization with a terminal, in the same manner as a base station. The relay may not receive an SS transmitted from the base station while transmitting the SS, and thus, the relay may need an SS for synchronization with the base station.

The SS transmitted from the base station for the synchronization with the relay may be referred to as a relay-synchronization signal (R-SS) to be distinguishable from the SS. The relay may also transmit the R-SS for synchronization with a subordinate relay. Accordingly, a transmission location of the R-SS in a downlink frame, a transmission period, and a search period may be additionally used.

An R-SS transmission method in an existing OFDM-based LTE-A system having a multi-hop relay is described as below.

First, the R-SS and an existing synchronization channel may be transmitted in different times, although the R-SS may use the same sequence as the existing synchronization channel. The first method may detect the same two synchronization channels during one frame.

Second, the R-SS may be not detected by a terminal since power allocated to the R-SS is lower than it allocated to the SS, although the R-SS may use the same sequence as the existing synchronization channel. According to the second method, the terminal may not detect the R-SS in a general environment, however, the terminal may detect the R-SS in a high-speed mobile environment, due to a fast-fading.

Third, a portion of a sequence is allocated to the synchronization channel and remaining sequence is allocated to the R-SS. According to the third method, the terminal may not detect the R-SS, however a number of sequences allocated to the synchronization channel may decrease.

Fourth, the R-SS may be generated by performing an exclusive or (XOR) between a synchronization channel sequence and a pseudorandom (PN) sequence. A plurality of new R-SSs may be generated by performing the XOR. The generated R-SS may have a lower correlation characteristic than the existing synchronization channel, however, a peak-to-average power ratio (PAPR) of the generated R-SS may increase. When a PAPR reduction scheme is applied, the correlation characteristic may decrease, namely, a trade-off may occur.

Fifth, the R-SS may be generated by allocating the existing SS in a reverse order in a frequency area. The R-SS generated according to the fifth method may have a lower correlation characteristic than the existing synchronization channel and have the same PAPR characteristic as the existing synchronization channel. However, the generated R-SS may have a symmetric characteristic and thus, may not be applied to a primary synchronization signal (PSS) defined in an LTE system.

### DISCLOSURE OF INVENTION

### Technical Goals

An aspect of the present invention provides a relay-synchronization signal (R-SS) transmitting apparatus and method in an orthogonal frequency division multiplexing (OFDM)-based Long Term Evolution Advanced (LTE-A) system having a multi-hop relay.

Another aspect of the present invention also provides an R-SS designing method for a synchronization process between a base station and a relay, and the R-SS designing method is for an International Mobile Telecommunications (IMT)-Advanced system having a mobile multi-hop relay.

### Technical Solutions

According to an aspect of an embodiment, there is provided a relay-synchronization signal (R-SS) transmitting apparatus in a multi-hop relay system, and the apparatus includes a synchronization signal (SS) generating unit to generate an SS constituted by a secondary synchronization signal (SSS) and a primary synchronization signal (PSS) for synchronization with a terminal, and a relay-synchronization signal (R-SS) generating unit to generate, based on the PSS, a relay-primary synchronization signal (R-PSS) having the same peak-to-average power ratio (PAPR) characteristic as the PSS and having a lower correlation characteristic than the PSS.

According to another aspect of an embodiment, there is provided an R-SS transmitting method in a multi-hop relay system, and the method includes generating an SS constituted by an SSS and a PSS for synchronization with a terminal, and generating, based on the PSS, an R-PSS having the same PAPR characteristic as the PSS and having a lower correlation characteristic than the PSS.

### Effect

According to an embodiment of the present invention, there is provided a relay-synchronization signal (R-SS) transmitting apparatus and method in an orthogonal frequency division multiplexing (OFDM)-based Long Term Evolution Advanced (LTE-A) system having a multi-hop relay. A transmitted R-SS has a low correlation characteristic with a synchronization signal (SS), a PAPR characteristic of the R-SS is not deteriorated compared with a peak-to-average power ratio (PAPR) characteristic of the SS, and a complexity of detecting the R-SS is not substantially increased compared with a complexity of the SS.

### BRIEF DESCRIPTION OF DRAWINGS

FIG. 1 is a diagram illustrating a scenario where a synchronization signal (SS) and a relay-synchronization signal (R-SS) are transmitted in a multi-hop relay system according to an embodiment.

FIG. 2 is a diagram illustrating a format of a frame based on a frequency division duplex (FDD) scheme in an LTE system.

FIG. 3 is a diagram illustrating a format of a frame when a new frequency area (FA) is allocated for a relay link according to an embodiment of the present invention.

FIG. 4 is a diagram illustrating a format of a frame that is classified into access zones and relay zones based on a predetermined sub-frame period according to an embodiment of the present invention.

FIG. 5 is a diagram illustrating a format of a frame that is classified into an access zone and a relay zone according to an embodiment of the present invention.

FIG. 6 is a diagram illustrating an R-SS transmitting apparatus in a multi-hop relay system according to an embodiment of the present invention.

FIG. 7 is a diagram illustrating a configuration of an R-SS generating unit in an R-SS transmitting apparatus according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

A relay-synchronization signal (R-SS) transmitting apparatus and method may be provided, and the R-SS transmitting apparatus and method may generate an R-SS having a peak-to-average power ratio (PAPR) characteristic that is not deteriorated compared with an existing synchronization signal (SS), and having the same correlation characteristic as the existing SS.

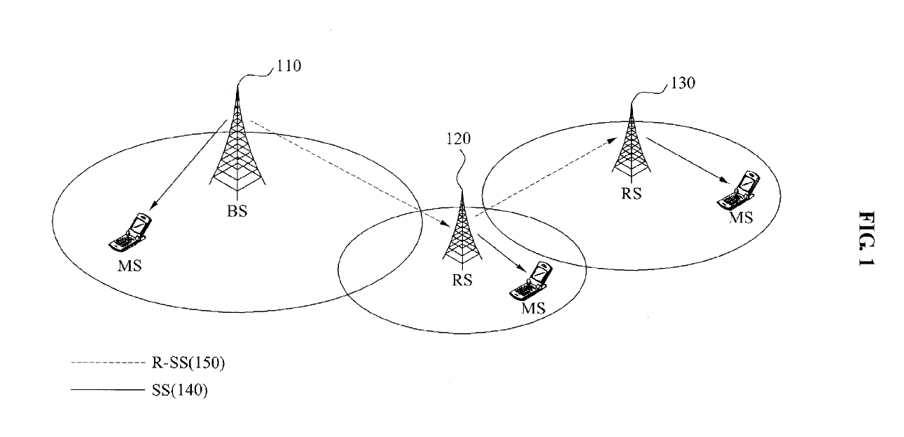

When a relay is installed, as a serving station, in an orthogonal frequency division multiplexing (OFDM)-based Long Term Evolution Advanced (LTE-A) system having a multi-hop relay, the relay may transmit an SS to enable a terminal to perform a cell search, like a base station. The relay may receive an R-SS transmitted from the base station to obtain synchronization with the base station. FIG. 1 illustrates a scenario where an SS and an R-SS are transmitted in a multi-hop relay system according to an embodiment. Referring to FIG. 1, a base station 110 and relays 120 and 130 may transmit an SS 140 for a cell search of terminals 112, 122, and 132, and an R-SS 150 for the relays 120 and 130 may be transmitted for a relay. The R-SS 150 for the relays 120 and 130 should not be detected during the cell search of the terminals 112, 122, and 132.

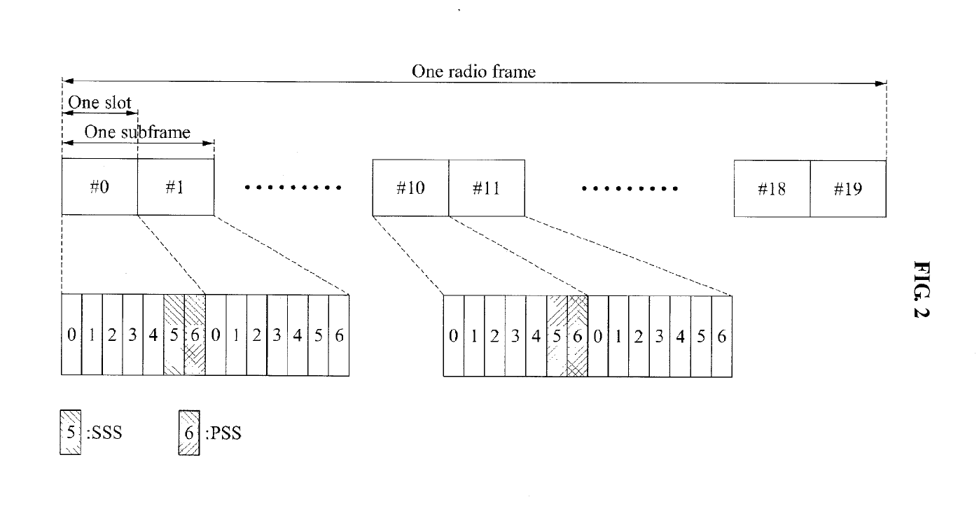

FIG. 2 illustrates a format of a frame based on a frequency division duplex (FDD) scheme in an LTE system. In an FDD mode, an uplink transmission and a downlink transmission is divided in a frequency area and thus, ten sub-frames may be transmitted to each of the downlink and the uplink during a 10 ms frame section. As illustrated in FIG. 2, an SS may be transmitted twice using a slot 0 and a slot 10. A different secondary synchronization signal (SSS) may be allocated to a symbol 5 of each slot, and the same primary synchronization signal (PSS) may be allocated to a last symbol of each slot. The SS may be constituted by the same PSS and the different SSS and may classify 504 cells. 504 Cell IDs may be generated by a combination of 168 eigen physical layer Cell ID groups and three eigen physical layer IDs in each group.

Referring to the cell search and the synchronization based on the PSS and the SSS, a terminal may synchronize a time based on a 5 ms unit using the PSS, may estimate a fractional carrier frequency offset(CFO), and may obtain a physical layer ID. Subsequently, the terminal may estimate, using the SSS located in a previous symbol of the PSS, the physical Cell ID group and a stating point of a frame, and a carrier frequency offset which is an integer multiple.

A relay may perform a synchronization process, in the same manner as the terminal Methods where the relay receives an R-SS from a base station is described as follows.

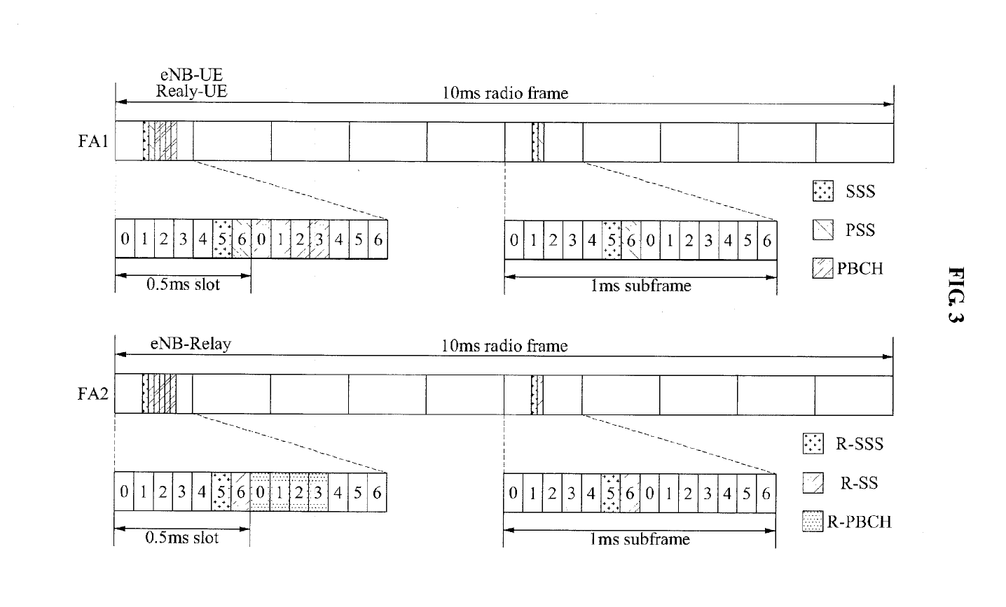

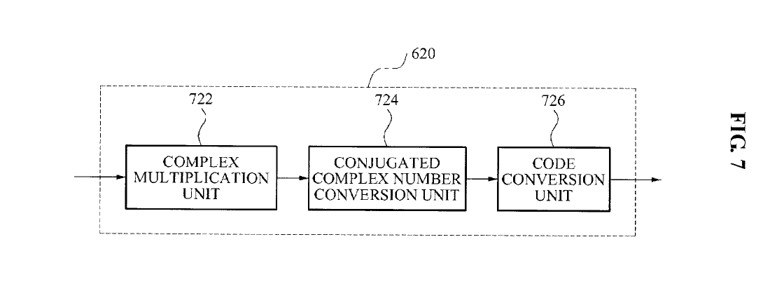

A first method is to allocate a new frequency area (FA) for a relay link. FIG. 3 illustrates a format of a frame when the new FA is allocated for the relay link according to an embodiment of the present invention. Referring to FIG. 3, an FA1 denotes a basic frequency band, and an F2 denotes the new FA that is newly allocated for the relay link. When the new FA2 is allocated for the relay link, an existing terminal that is operated in the FA1 may perform a transmission and a reception in the same manner as usual regardless of existence of the relay. Accordingly, there is no need to design a new frame format, such as selection of a location of the R-SS, a transmission period, and the like, and the R-SS may use an existing SS. Although the new frequency band for the relay is allocated, another FA other than the FA1 may be detected from a radio frequency (RF) end and may be accessible. In this case, the terminal may detect the R-SS instead of the existing SS. Accordingly, when the new frequency band for the relay is allocated, an R-SS having a lower correlation characteristic than the existing SS may be generated. The R-SS having the lower correlation characteristic will be described with reference to FIG. 7.

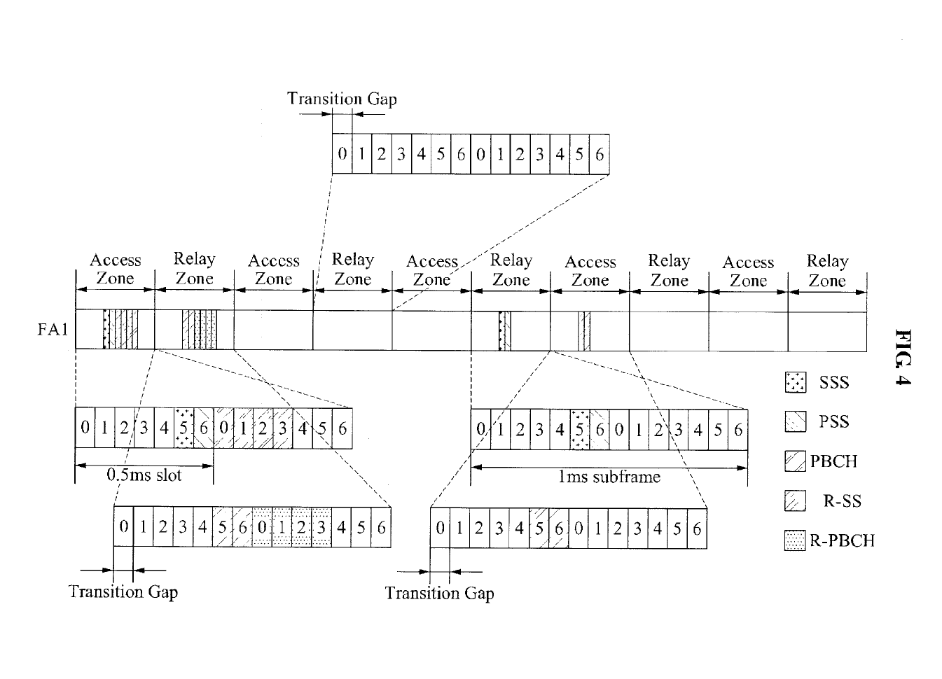

A second method is to classify an access zone for a terminal and a relay zone for a relay based on a predetermined sub-frame period. FIG. 4 illustrates a format of a frame that is classified into access zones and relay zones based on a predetermined sub-frame period according to an embodiment of the present invention. Referring to FIG. 4, a transition gap is required when a reception mode is changed into a transmission mode or vice versa, in a half duplex relay, as opposed to in a full duplex relay. The transition gap may be located in a first symbol of an access zone or a first symbol of a relay zone. The R-SS may be constituted by a relay-primary synchronization signal (R-PSS) or a relay-second synchronization signal (R-SSS). The R-SS may be allocated to 6 resource block (RB), in the same manner as a synchronization channel, and the R-SS may be transmitted using the last two symbols in two remaining slots excluding a slot 0 and a slot 10 which are used in transmitting the SS, to enable the relay to receive the R-SS regardless of a format of a frame having a normal/extend CP.

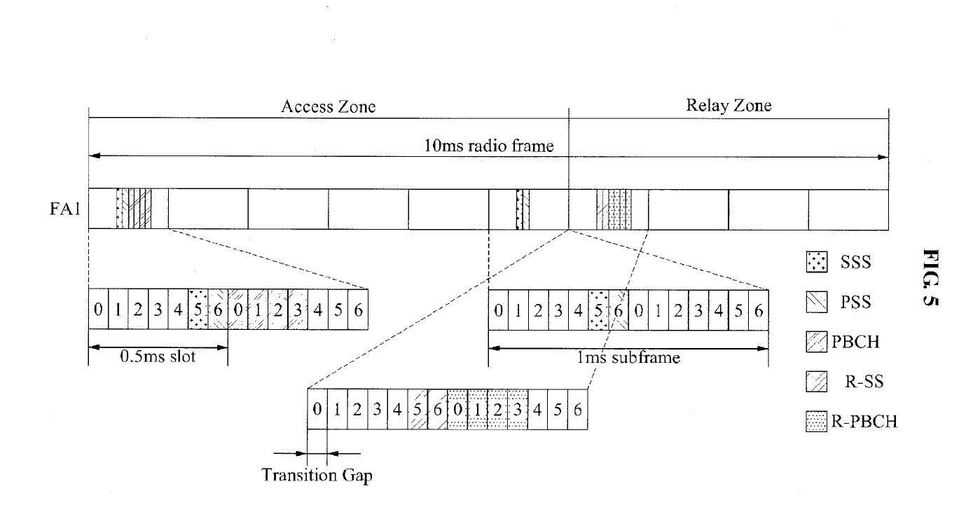

A third method is to classify a single frame into an access zone and a relay zone to reduce a transition gap compared with the second method. FIG. 5 illustrates a format of a frame that is classified into an access zone and a relay zone according to an embodiment of the present invention.

An R-SS transmitted to the relay according to an embodiment of the present invention may be designed to have characteristics as below.

First, an SS for synchronization with a terminal is reused R-SS.

Second, the R-SS and the SS have low correlation characteristics so that the R-SS is not detected during a cell search of an existing terminal

Third, the correlation characteristic of the R-SS is not deteriorated compared with the correlation characteristic of the SS.

Fourth, a PAPR characteristic of the R-SS is not deteriorated compared with a PAPR characteristic of the SS.

Additionally, a complexity of detecting an R-SS may not be increased compared with a complexity of detecting the SS.

The proposed R-SS may use an SSS of the SS and may only change a PSS. Specifically, an R-PSS may not be detected during the cell search of the terminal. During the cell search of the terminal, the SSS may be detected by a detection of the PSS, and thus, when the R-PSS is not detected, the terminal may not detect R-SSS. Accordingly, the R-SSS may reuse the existing SSS as is.

Referring to a characteristic of the PSS of the SS prior to referring to a characteristic of the R-SS, a PSS of an LTE system may be expressed as given in Equation 1.

P^{u}(k)=e^{-j·π·u·k·(k+1)/N}^{_{ZC}} k=0, . . . , N_{ZC}−1 [Equation 1]

In Equation 1, P^{u} denotes the PSS, u denotes a root index of the PSS and has a value of 25, 29, or 34, and N_{ZC} denotes a length of a sequence and has a value of 63.

When a sum of two root indexes is equivalent to N_{ZC}, PSSs having the two root indexes may be in a complex conjugate symmetry relationship as expressed by Equation 2, regardless of a temporal area and a frequency area.

$$\begin{matrix}{( {P}^{Nzc - u} ( k ) )}^{*} = cos ( - π \cdot ( {N}_{ZC} - u ) \cdot k \cdot ( k + 1 ) / {N}_{ZC} ) + \\ j sin ( - π \cdot ( {N}_{ZC} - u ) \cdot k \cdot ( k + 1 ) / {N}_{ZC} ) \\ = cos ( π \cdot u \cdot k \cdot ( k + 1 ) / {N}_{ZC} ) - \\ j sin ( π \cdot u \cdot k \cdot ( k + 1 ) / {N}_{ZC} )\end{matrix} \\ {P}^{u} ( k ) = {( {P}^{Nzc - u} ( k ) )}^{*} , \\ when {N}_{ZC} is odd , \\ k = 0 , … , {N}_{ZC} - 1 \qquad [ Equation 2 ]$$

P^{u} denotes a PSS, u denotes a root index of the PSS.

A PSS of which a root index is 29 and a PSS of which a root index is 34 are in a complex conjugate symmetry relationship, and thus, two root indexes may be detected through a single correlation calculation. PSSs corresponding to all root indexes may have the same correlation characteristic.

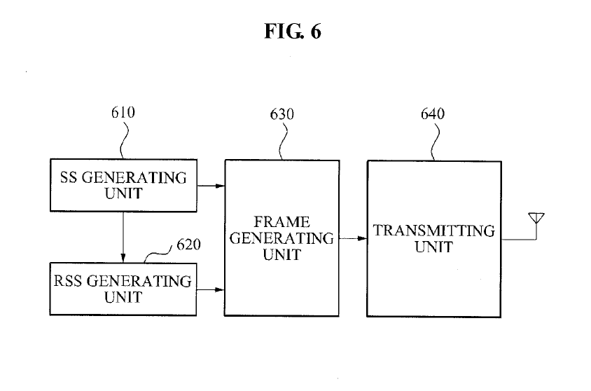

FIG. 6 illustrates an R-SS transmitting apparatus in a multi-hop relay system according to an embodiment of the present invention. Referring to FIG. 6, the R-SS transmitting apparatus may include an SS generating unit 610, an R-SS generating unit 620, a frame generating unit 630, and a transmitting unit 640.

The SS generating unit 610 may generate an SS constituted by an SSS and a PSS for synchronization with a terminal.

The R-SS generating unit 620 may generate, based on the PSS generated by the SS generating unit 610, an R-PSS having the same PAPR characteristic as the PSS and having a lower correlation characteristic than the PSS. The R-SS generating unit 620 will be described with reference to FIG. 7.

The frame generating unit 630 may generate a frame as described with reference to FIGS. 3 through 5. The frame generating unit 630 may generate a frame to which a new FA is allocated for a relay link. The frame generating unit 630 may generate the frame to alternately include, based on a predetermined sub-frame period, an access zone for a terminal and a relay zone for a relay. The frame generating unit 630 may generate the frame to include a single access zone and a single relay zone.

The transmitting unit 640 may transmit the generated frame to the relay.

FIG. 7 illustrates a configuration of an R-SS generating unit in an R-SS transmitting apparatus according to an embodiment of the present invention. Referring to FIG. 7, the R-SS generating unit 620 may include a complex multiplication unit 722, a conjugate complex number conversion unit 724, and a code conversion unit 726.

The complex multiplication unit 722 may receive a PSS generated by the SS generating unit 610 and may multiply the received PSS by a predetermined complex number. The conjugated complex number conversion unit 724 may conjugate the PSS of the complex number to convert a PSS of a conjugated complex number. The code conversion unit 726 may perform a code-conversion to the PSS of the conjugated complex number to generate the R-PSS having a low correlation characteristic.

The R-PSS generated by the complex multiplication unit 722, the conjugated complex number conversion unit 724, and the code conversion 726 may be expressed by Equation 3.

P_{R}^{u}=−(jP^{u})*

where P^{u}(k)=e^{-j·π·u·k·(k+1)/N}^{_{ZC}} k=0, . . . , N_{ZC}−1 [Equation 3]

In Equation 3, [symbol] denotes the R-PSS generated from denoting the PSS. The R-PSS may use 25, 29, or 34 as the root index value, like the PSS.

R-PSSs corresponding to all root indexes according to the present invention may have the same correlation characteristics, like the PSS. Accordingly, the R-PSS may use 25, 29, or 34 as the root index, like the PSS. An R-PSS of which a root index is 29 and an R-PSS of which a root index is 34 may have a complex conjugated symmetric characteristic as expressed by Equation 4.

$$\begin{matrix}{( {P}_{R}^{Nzc - u} ( k ) )}^{*} = sin ( - π \cdot ( {N}_{ZC} - u ) \cdot k \cdot ( k + 1 ) / {N}_{ZC} ) + \\ j cos ( - π \cdot ( {N}_{ZC} - u ) \cdot k \cdot ( k + 1 ) / {N}_{ZC} ) \\ = - sin ( - π \cdot u \cdot k \cdot ( k + 1 ) / {N}_{ZC} ) + \\ j cos ( π \cdot u \cdot k \cdot ( k + 1 ) / {N}_{ZC} )\end{matrix} \\ {P}_{R}^{u} ( k ) = - {( {P}_{R}^{{N}_{ZC} - u} ( k ) )}^{*} , \\ when {N}_{ZC} is odd , \\ k = 0 , … , {N}_{ZC} - 1 \qquad [ Equation 4 ]$$

The root indexes 29 and 34 of the PSS and the R-PSS may have the complex conjugated symmetric characteristic, and thus, may be detected by a single correlation calculation as expressed by Equation 2 and Equation 4.

First, the correlation calculation of the PSS may be expressed by Equation 5.

$$\begin{matrix}{R}^{u} ( d ) = ( {R}_{II} + {R}_{QQ} ) + j ( {I}_{QI} - {I}_{IQ} ) & [ Equation 5 ] \\ {R}^{Nzc - u} ( d ) = ( {R}_{II} - {R}_{QQ} ) + j ( {I}_{QI} - {I}_{IQ} ) & \\ where & \\ {R}_{II} = {\sum }_{n = 0}^{N - 1} ( {r}_{I} ( n + d ) {p}_{I}^{u} ( n ) ) , & \\ {R}_{QQ} = {\sum }_{n = 0}^{N - 1} ( {r}_{Q} ( n + d ) {p}_{Q}^{u} ( n ) ) , & \\ {I}_{QI} = {\sum }_{n = 0}^{N - 1} ( {r}_{Q} ( n + d ) {p}_{I}^{u} ( n ) ) , & \\ {I}_{IQ} = {\sum }_{n = 0}^{N - 1} ( {r}_{I} ( n + d ) {p}_{Q}^{u} ( n ) ) & \end{matrix}$$

In Equation 5, R^{u}(d) is a result of a cross-correlation calculation between a received signal and P^{u} that is a PSS having u as a root index, based on d that is a range of the cross-correlation calculation, and R^{Nzc-u}(d) is a result of a cross-correlation calculation between the received signal and P^{N}^{_{ZC}}^{-u} that is a PSS having N_{ZC}−u as a root index. r_{I} is a real number of the received signal, r_{Q} is an imaginary number of the received signal, p^{u}_{I} is a real number of the PSS of which the root index is u, p_{Q}^{u} is an imaginary number of the PSS of which the root index is u, R_{II} is a correlation calculation value between p_{I}^{u} and r_{I} and is a real number, R_{QQ} is a correlation calculation value between p_{Q}^{u} and r_{Q} and is a real number, I_{QI} is a correlation calculation value between p_{I}^{u} and r_{Q} and is an imaginary number, and I_{IQ} is a correllation calculation value between p_{Q}^{u} and r_{I} and is an imaginary number.

All root indexes may be detected by total two correlation calculations from the PSS.

A correlation calculation of the R-PSS may be expressed by Equation 6.

$$\begin{matrix}{R}_{R}^{u} ( d ) = ( {R}_{II} + {R}_{QQ} ) + j ( {I}_{QI} - {I}_{IQ} ) & [ Equation 6 ] \\ {R}_{R}^{{N}_{ZC} - u} ( d ) = ( - {R}_{II} - {R}_{QQ} ) + j ( {I}_{QI} - {I}_{IQ} ) & \\ where & \\ {R}_{II} = {\sum }_{n = 0}^{N - 1} ( {r}_{I} ( n + d ) {p}_{I}^{u} ( n ) ) , & \\ {R}_{QQ} = {\sum }_{n = 0}^{N - 1} ( {r}_{Q} ( n + d ) {p}_{Q}^{u} ( n ) ) , & \\ {I}_{QI} = {\sum }_{n = 0}^{N - 1} ( {r}_{Q} ( n + d ) {p}_{I}^{u} ( n ) ) , & \\ {I}_{IQ} = {\sum }_{n = 0}^{N - 1} ( {r}_{I} ( n + d ) {p}_{Q}^{u} ( n ) ) & \end{matrix}$$

In Equation 6, R_{R}^{u}(d) is a result of a mutual correlation calculation between a received signal and P_{R}^{u} that is an R-PSS having u as a root index, based on d that is a range of the mutual correlation calculation, and R_{R}^{N}^{_{ZC}}^{-u}(d) is a result of a mutual correlation calculation between the received signal and P_{R}^{N}^{_{ZC}}^{-u} that is a PSS having N_{ZC}−u as a root index. r_{I} is a real number of the received signal, r_{Q} is an imaginary number of the received signal, p_{I}^{u} is a real number of the PSS of which the root index is u, p_{Q}^{u} is an imaginary number of the PSS of which the root index is u, R_{II} is a correlation calculation value between p_{I}^{u} and r_{I} and is a real number, R_{QQ} is a correlation calculation value between p_{Q}^{u} and r_{Q} and is a real number, I_{QI} is a correlation calculation value between p_{I}^{u} and r_{Q} and is an imaginary number, and I_{IQ} is a correllation calculation value between p_{Q}^{u} and r_{I} and is an imaginary number.

All root indexes may be detected, based on the complex conjugated symmetric characteristic, by a total two correlation calculations from the R-PSS.

When a relay receives the R-PSS of the present invention, a frame may be detected, and a cell search is performed by detecting a root index of an SSS and a root index of the R-PSS. The detection of the frame using the R-PSS may be performed by a cross-correlation calculation in a temporal area as expressed by Equation 7.

$$\hat{d} = {argmax}_{d} \{ R ( d ) \} \\ R ( d ) = ( {\vert {\sum }_{n = 0}^{N - 1} {p}_{R}^{{u}^{*}} ( n ) r ( n + d ) \vert}^{2} ) / P ( d ) \\ where \\ P ( d ) = {\vert {\sum }_{n = 0}^{N - 1} {r}^{*} ( n + d ) \vert}^{2} \qquad [ Equation 7 ]$$

In Equation 7, [symbol] denotes an estimated timing offset, R(d) denotes a result of a mutual correlation calculation between a received signal and an R-PSS, based on d that is a range of a mutual correlation calculation, P_{R}^{u} denotes the R-PSS, and u denotes a root index of the R-PSS.

The embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus of transmitting a relay-synchronization signal (R-SS) in a multi-hop relay system, the apparatus comprising:
a synchronization signal (SS) generating unit to generate an SS constituted by a secondary synchronization signal (SSS) and a primary synchronization signal (PSS) for synchronization with a terminal; and
a relay-synchronization signal (R-SS) generating unit to generate, based on the PSS, a relay-primary synchronization signal (R-PSS) having the same peak-to-average power ratio (PAPR) characteristic as the PSS and having a lower correlation characteristic than the PSS.

2. The apparatus of claim 1, wherein the R-SS generating unit comprises:
a complex multiplication unit to multiply the PSS by a predetermined complex number to calculate a PSS of the complex number;
a conjugated complex number conversion unit to conjugate the PSS of the complex number to convert a PSS of a conjugated complex number; and
a code conversion unit to perform a code-conversion to the PSS of the conjugated complex number to generate the R-PSS.

3. The apparatus of claim 1, wherein the R-SS generating unit allocates a real number of the PSS as an imaginary number of the R-PSS, and allocates an imaginary number of the PSS as a real number of the R-PSS, to generate the R-PSS.

4. The apparatus of claim 1, wherein the R-SS generating unit generates a relay-secondary synchronization signal (R-SSS) constituting the R-SS, to be the same as the SSS.

5. The apparatus of claim 1, further comprising:
a frame generating unit to generate a basic frame including the SS that uses a basic frequency band to link with the terminal, and to generate a relay frame including an R-SS that uses a predetermined relay frequency band to link with a relay, the R-SS being constituted by the R-PSS and the R-SSS.

6. The apparatus of claim 5, wherein the frame generating unit successively arranges, in the relay frame, the R-SS including the R-PSS and the R-SSS, and arranges the R-PSS to be located in a symbol next to the R-SSS.

7. The apparatus of claim 5, wherein the frame generating unit generates the basic frame and the relay frame to be in the same format.

8. The apparatus of claim 1, further comprising:
a frame generating unit to generate a frame to alternately include, based on a predetermined sub-frame period, an access zone for a terminal and a relay zone for a relay, to include the SS in a predetermined location of the access zone, and to include the R-SS including the R-PSS and the R-SSS in a predetermined location of the relay zone.

9. A method of transmitting an R-SS in a multi-hop relay system, the method comprising:
generating an SS constituted by an SSS and a PSS for synchronization with a terminal; and
generating, based on the PSS, an R-PSS having the same PAPR characteristic as the PSS and having a lower correlation characteristic than the PSS.

10. The method of claim 9, wherein the generating of the R-PSS comprises:
calculating a PSS of a complex number by multiplying the PSS by a predetermined complex number;
converting a PSS of a conjugated complex number by conjugating the PSS of the complex number; and
generating the R-PSS by performing a code-conversion to the PSS of the conjugated complex number.

11. The method of claim 9, wherein the generating of the R-PSS comprises:
generating the R-PSS by allocating a real number of the PSS as an imaginary number of the R-PSS and by allocating an imaginary number of the PSS as a real number of the R-PSS.

12. The method of claim 9, further comprising:
generating an R-SSS constituting the R-SS, to be the same as the SSS.

13. The method of claim 9, further comprising:
generating a basic frame including the SS that uses a basic frequency band to link with the terminal, and
generating a relay frame including an R-SS that uses a predetermined relay frequency band to link with a relay, the R-SS being constituted by the R-PSS and the R-SSS.

14. The method of claim 13, wherein the generating of the relay frame comprises successively arranging, in the relay frame, the R-SS including the R-PSS and the R-SSS, and ananging the R-PSS to be located in a symbol next to the R-SSS.

15. The method of claim 9, further comprising:
generating a frame to alternately include, based on a predetermined sub-frame period, an access zone for a terminal and a relay zone for a relay, to include the SS in a predetermined location of the access zone, and to include the R-SS including the R-PSS and the R-SSS in a predetermined location of the relay zone.
